(19) United States
(12) Patent Application Publication
(10) Pub. No.: US 2024/0084956 A1
(43) Pub. Date: Mar. 14, 2024

(54) DISPLAY APPARATUS

(71) Applicant: SAMSUNG ELECTRONICS CO., LTD., Suwon-si (KR)

(72) Inventors: Sanggoo LEE, Suwon-si (KR); Sunggi KIM, Suwon-si (KR)

(73) Assignee: SAMSUNG ELECTRONICS CO., LTD., Suwon-si (KR)

(21) Appl. No.: 18/207,426

(22) Filed: Jun. 8, 2023

(30) Foreign Application Priority Data
Sep. 8, 2022 (KR) 10-2022-0114534
Oct. 18, 2022 (KR) 10-2022-0134486

(51) Int. Cl. F16M 11/20; F16M 11/10; F16M 11/24

(52) U.S. Cl. CPC F16M 11/2028; F16M 11/10; F16M 11/24

(57) ABSTRACT

Provided is a display apparatus including a display, a support arm coupled to a rear surface of the display, and a support stand coupled to the support arm and configured to move the support arm along a vertical direction where the display is pivotally rotatable between a first orientation in which a long side of the display is laterally disposed and a second orientation in which the long side of the display is longitudinally disposed. The support stand is configured to upwardly move the display based on the display being rotated from the first orientation to the second orientation, and downwardly move the display based on the display being rotated from the second orientation to the first orientation.

### CROSS-REFERENCE TO RELATED APPLICATION(S)

This application is a bypass continuation of International Application No. PCT/KR2023/007020, filed on May 23, 2023, which is based on and claims priority to Korean Patent Application No. 10-2022-0114534 filed on Sep. 8, 2022, and Korean Patent Application No. 10-2022-0134486 filed on Oct. 18, 2022, in the Korean Intellectual Property Office, the disclosures of which are incorporated by reference herein in their entireties.

### BACKGROUND

### Field

The disclosure relates to a display apparatus including a display and a support device for supporting the display to enable a rotation and an upward and downward movement of the display.

### Description of the Related Art

A display apparatus is an output apparatus for converting acquired or stored electrical information into visual information and displaying the converted electrical information to a user.

The display apparatus may include a display for displaying an image and a support device for supporting the display. The support device may be provided to support the display so that a front surface of the display faces the user.

The support device may support the display to be movable upward and downward within a predetermined range. In addition, the support device may support the display to perform a pivot rotation.

When the display is rotated without being sufficiently spaced apart from a floor surface, the display may collide with the floor surface and thus the display may be damaged.

An aspect of the disclosure provides a display apparatus capable of preventing a display from colliding with a floor surface due to being rotated.

An aspect of the disclosure provides a display apparatus capable of preventing a collision between a display and a floor surface by allowing the display to simultaneously perform rotation and upward movement when the display is in a position to collide with the floor surface due to pivot rotation.

### SUMMARY

According to an aspect of the disclosure, there is provided a display apparatus including a display, a support arm coupled to a rear surface of the display, and a support stand coupled to the support arm and configured to move the support arm along a vertical direction, and the display is pivotally rotatable with the support arm between a first orientation in which a long side of the display is laterally disposed and a second orientation in which the long side of the display is longitudinally disposed. The support stand is configured to upwardly move the display based on the display being rotated from the first orientation to the second orientation, and downwardly move the display based on the display being rotated from the second orientation to the first orientation.

According an aspect of the disclosure, there is provided a display apparatus including a display, a support arm coupled to a rear surface of the display, and a support stand coupled to the support arm where the support stand is configured to upwardly move the display based on the display being rotated in a first direction from a first orientation to a second orientation different from the first orientation, and downwardly move the display based on the display being rotated in a second direction opposite to the first direction from the second orientation to the first orientation.

### BRIEF DESCRIPTION OF THE DRAWINGS

FIG. 1 is a perspective view illustrating a display apparatus according to an embodiment in which a display is laterally disposed.

FIG. 2 is a perspective view illustrating a display apparatus according to an embodiment in which a display is longitudinally disposed.

FIG. 3 is a side view illustrating a display apparatus according to an embodiment.

FIG. 4 is a schematic exploded view illustrating a display apparatus from an angle according to an embodiment.

FIG. 5 is a view illustrating FIG. 4 from another angle.

FIG. 6 is a schematic exploded view illustrating a support stand of a display apparatus according to an embodiment.

FIG. 7 is an exploded view illustrating main components of a support stand of a display apparatus from an angle according to an embodiment.

FIG. 8 is a view illustrating FIG. 7 from another angle.

FIG. 9 is a view illustrating an inside of a support stand when a display is laterally disposed in a display apparatus according to an embodiment.

FIG. 10 is a view illustrating an inside of a support stand when a display is longitudinally disposed in a display apparatus according to an embodiment.

FIG. 11 is an enlarged view illustrating a part of a display apparatus according to an embodiment.

### DETAILED DESCRIPTION

Embodiments described in the specification and configurations shown in the accompanying drawings are merely examples of the disclosure, and various modifications may replace the embodiments and the drawings of the disclosure at the time of filing of the application.

Further, identical symbols or numbers in the drawings of the disclosure denote components or elements configured to perform substantially identical functions.

Further, terms used herein are only for the purpose of describing particular embodiments and are not intended to limit to the disclosure. The singular form is intended to include the plural form as well, unless the context clearly indicates otherwise. It should be further understood that the terms “include,” “including,” “have,” and/or “having” specify the presence of stated features, integers, steps, operations, elements, components, and/or groups thereof, but do not preclude the presence or addition of one or more other features, integers, steps, operations, elements, components, and/or groups thereof.

Further, it should be understood that, although the terms “first,” “second,” etc. may be used herein to describe various elements, the elements are not restricted by the terms, and the terms are only used to distinguish one element from another. For example, a first element could be termed a second element, and similarly, a second element could be termed a first element without departing from the scope of the disclosure. The term “and/or” includes combinations of one or all of a plurality of associated listed items.

The terms “front”, “rear”, “left”, “right”, and the like as herein used are defined with respect to the drawings, but the terms may not restrict the shape and position of the respective components.

Hereinafter, embodiments will be described in detail with reference to the accompanying drawings.

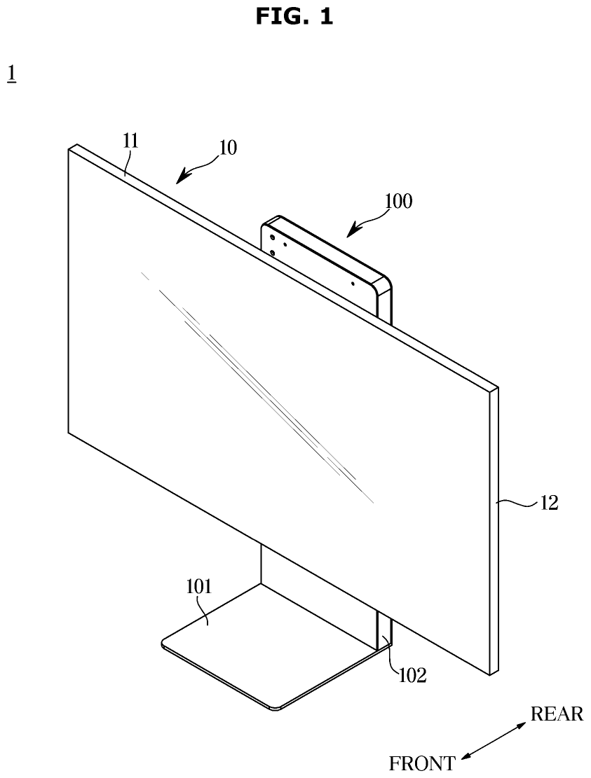

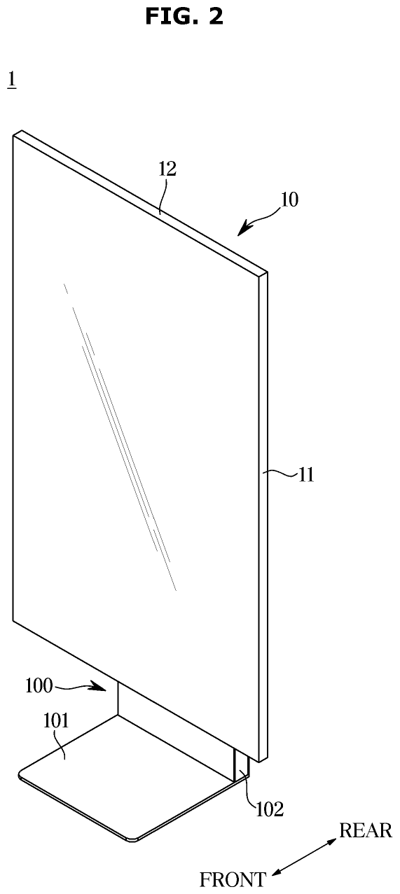

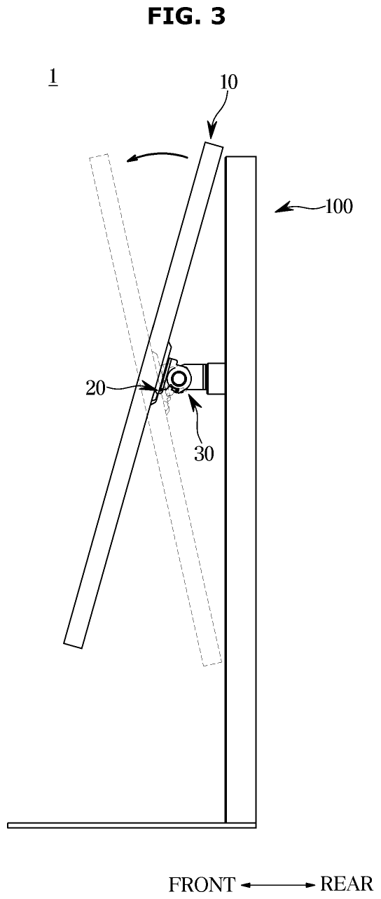

FIG. 1 is a perspective view illustrating a display apparatus according to an embodiment, which shows a state in which a display is laterally disposed. FIG. 2 is a perspective view illustrating a display apparatus according to an embodiment, which shows a state in which a display is longitudinally disposed. FIG. 3 is a side view illustrating a display apparatus according to an embodiment.

A display apparatus 1 may include a display 10, and a support stand 100 that supports the display 10. The display apparatus 1 may include a support arm 30 connecting the display 10 and the support stand 100.

The display 10 is a device capable of displaying information, reference materials, data, and the like as characters, figures, graphs, images, and the like. The display 10 may include a television, a monitor, and the like.

The display 10 may be configured to display a screen. The display 10 may include a self-emissive display panel, such as an organic light-emitting diode (OLED), or a non-emissive display panel, such as a liquid crystal display (LCD). There is no particular limitation on the type of the display panel.

The display 10 may be provided so that the length of a lateral side and the length of a longitudinal side are different from each other. That is, the display 10 may be provided to have a long side 11 and a short side 12. The display 10 may be provided in a rectangular plate shape.

The display apparatus 1 may include support devices 30 and 100 that support the display 10. The support devices 30 and 100 may include a support arm 30 and a support stand 100. The support arm 30 may be provided to connect the display 10 and the support stand 100, and the support stand 100 may support the display 10 such that a screen of the display 10 faces a user.

The support stand 100 may include a base 101 provided to be in contact with a floor surface, and a stand 102 extending upwardly from the base 101. The base 101 may function to substantially extend a bottom surface area of the stand 102. By substantially extending the bottom surface area of the stand 102, the base 101 enables the support stand 100 to be stably self-supporting on the floor surface.

Referring to FIGS. 1 and 2, the display 10 may be provided to be pivot-rotatable with respect to the support stand 100. In other words, the support stand 100 may support the display 10 such that the display 10 is pivotally rotatable. The display 10 may be pivotally rotatable between a first orientation in which the long sides 11 are disposed horizontally, and a second orientation in which the long sides 11 are disposed vertically.

The display 10 may rotate in one direction from the first orientation to be positioned in the second orientation. The display 10 may be rotated in another direction opposite to the one direction from the second orientation to be positioned in the first orientation. The support stand 100 may support the support arm 30 and the display 10 coupled with the support arm 30 to enable rotation between the first orientation and the second orientation. The first orientation may be referred to as a landscape orientation, and the second orientation may be referred to as a portrait orientation.

Referring to FIG. 3, the display 10 may be provided to be tilt-rotatable. As the display 10 is tilt-rotated, the screen of the display 10 may face downwardly or upwardly. Tilt rotation may refer to rotation of the display 10 about a predetermined axis parallel to the floor surface within a predetermined angular range. The support arm 30 may support the display 10 in a tilt-rotatable manner.

Although not shown in FIGS. 1 to 3, the support stand 100 may support the support arm 30 and the display 10 such that the support arm 30 and the display 10 are movable in an upward and downward direction with respect to the support stand 100.

When the display 10 arranged in the landscape orientation rotates without being sufficiently spaced apart from a floor surface in the upper-lower direction, a corner portion of the display 10 may collide with the floor surface, causing the display 10 to be damaged. The “floor surface” may refer to a physical space in which the support stand 30 is placed. The “floor surface” may refer to some area of an upper surface of a desk or an object having a flat upper surface.

In related devices, in order to prevent collision with the floor surface during a rotation of the display, the user needs to position the display at the uppermost end of the support stand and then rotate the display. However, when the user inadvertently rotates the display without positioning the display at the uppermost end of the support stand, the display may collide with the floor surface, so that the display is damaged as described above.

According to an embodiment, the display 10 may be prevented from colliding with the floor surface due to the rotation of the display 10. Specifically, when the display 10 disposed in the landscape orientation is rotated to the portrait orientation, the display 10 is configured to move upwardly with respect to the support stand 100 in conjunction with the rotation, thereby preventing collision of the display 10 with the floor surface. A specific description of such an operation will be described later.

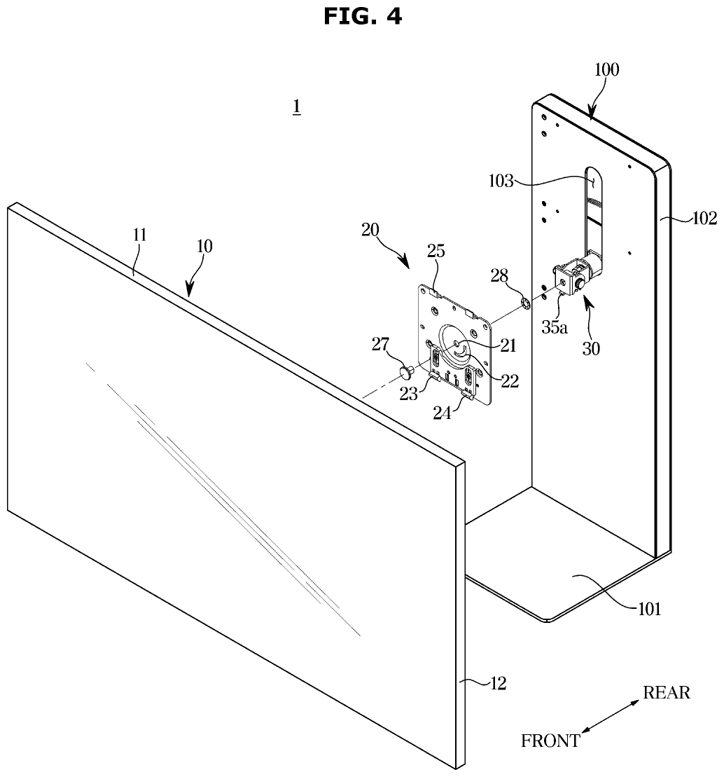

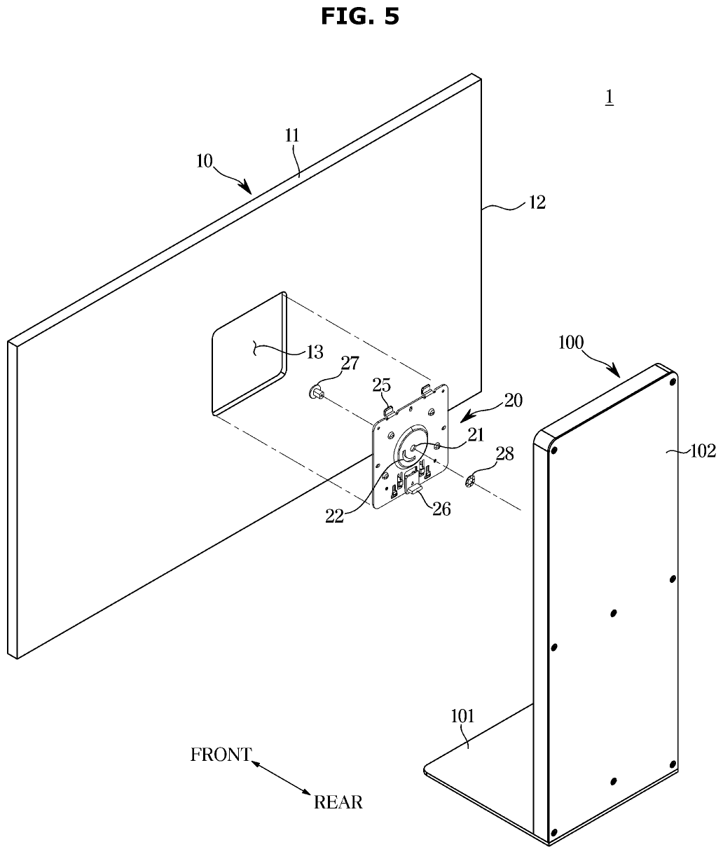

FIG. 4 is a schematic exploded view illustrating a display apparatus from an angle according to an embodiment. FIG. 5 is a view illustrating FIG. 4 from another angle.

Referring to FIGS. 4 and 5, a display apparatus 1 may include a display 10 displaying a screen, a bracket 20 coupled to a rear surface of the display 10, a support arm 30 coupled to the bracket 20 to support the display 10, and a support stand 100 supporting the support arm 30 that is upwardly and downwardly movable and pivotally rotatable. The support arm 30 may tilt-rotatably support the display 10. The support arm 30 may be upwardly and downwardly movable between a bottom and a top of a stand opening 103 formed in a front surface of the support stand 100.

The bracket 20 may be inserted and engaged in a bracket groove 13 provided in the rear of the display 10. The bracket 20 may include a bracket hole 21 provided in a center portion of the bracket 20. At least a portion of a bracket retainer 27 which couples the bracket 20 to the support arm 30, may be inserted into the bracket hole 21.

The bracket 20 may include a guide hole 22. In the guide hole 22, a guide protrusion 35a of the support arm 30 may be inserted. The guide protrusion 35a may be movable within the guide hole 22. The guide hole 22 may limit the range of movement of the guide protrusion 35a to approximately 90 degrees.

The bracket 20 may further include a coupling plate 23. The coupling plate 23 may be provided with a first coupling protrusion 24. The bracket 20 may include a second coupling protrusion 25 provided at a top of the bracket 20. The coupling plate 23 may be coupled to the bracket 20 so as to be movable up and down within a predetermined range with respect to the bracket 20. A user may move the coupling plate 23 upwardly with respect to the bracket 20 by gripping a plate protrusion 26 provided on a rear surface of the bracket 20 and then moving the plate protrusion 26 upwardly.

When coupling the bracket 20 to the bracket groove 13 provided on the rear surface of the display 10, the second coupling protrusion 25 of the bracket 20 is inserted into the second coupling groove (not shown) provided on an inner side of the bracket groove 13. Once the second coupling protrusion 25 is inserted into the second coupling groove, the plate protrusion 26 is moved upwardly and the bracket 20 is inserted into the bracket groove 13, and the plate protrusion 26 is moved downwardly. As the plate protrusion 26 is moved downward, the first coupling protrusion 25 may be inserted into the first coupling groove (not shown) provided on the inner side of the bracket groove 13. Through this process, the bracket 20 may be primarily coupled to the rear surface of the display 10. By engaging a fastener in the plurality of fastening holes provided in the bracket 20 and the bracket groove 13 of the display 10, the bracket 20 may be fully secured to the rear surface of the display 10. In other words, the bracket 20 may not be detachable from the rear of the display 10.

The bracket 20 may be coupled to the support arm 30 provided at a rear side of the bracket 20. The bracket 20 may be coupled to the support arm 30 such that the bracket 20 is pivotally rotatable within a predetermined angular range. Specifically, the bracket 20 may be coupled to the support arm 30 such that the bracket 20 is pivotally rotatable within a range of approximately 90 degrees. Referring to FIGS. 4 and 5, the guide protrusion 35a provided on the support arm 30 may be movable within the guide hole 22 of the bracket 20. The guide holes 22 may be arranged in an arc shape within a range of approximately 90 degrees. The guide protrusion 35a may move from one end of the guide hole 22 to the other end of the guide hole 22. Alternatively, the guide protrusion 35a may remain fixed and the bracket 20 may be rotated within the range of approximately 90 degrees. As the bracket 20 rotates, the guide protrusion 35a may move from one end of the guide hole 22 to the other end of the guide hole 22.

The bracket 20 may be coupled to the support arm 30, by at least a portion of the bracket retainer 27 engaging the support arm 30 through the bracket hole 21 and a bracket washer 28. The bracket 20 may be pivotally rotatable within a predetermined angular range with respect to the support arm 30. This allows the display 10 to be pivotally rotated within a predetermined angular range with respect to the support arm 30. The predetermined angular range may be approximately 90 degrees.

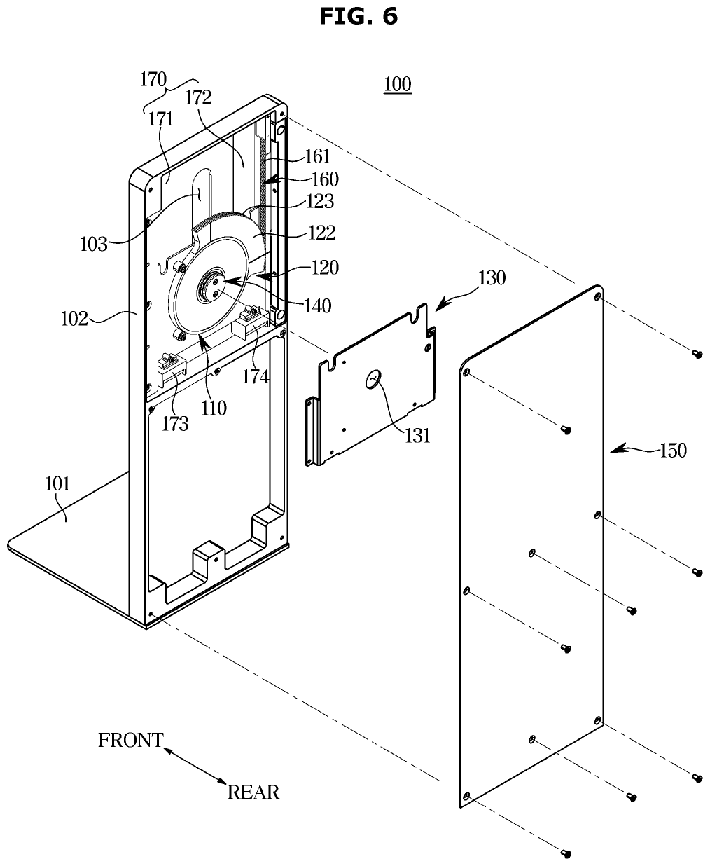

FIG. 6 is a schematic exploded view illustrating a support stand of a display apparatus according to an embodiment.

Referring to FIG. 6, the support stand 100 may accommodate a first support plate 110, a rotating member 120, and a second support plate 130 in the support stand 100. The first support plate 110, the rotating member 120, and the second support plate 130 are coupled together and can move within a predetermined range in upward and downward directions. The rotating member 120 may be disposed between the first support plate 110 and the second support plate 130. The rotating member 120 may be fixed inside the support stand 100 by the first support plate 110 and the second support plate 130. The first support plate 110 and the second support plate 130 may each be coupled to the support stand 100 so as to be movable up and down within the support stand 100. As the rotating member 120 rotates, the first support plate 110, the rotating member 120 and the second support plate 130 may move together in upward and downward directions. The support stand 100 may further include a cover plate 150 covering a rear surface of the support stand 100. The cover plate 150 may cover an opened rear surface of the support stand 100.

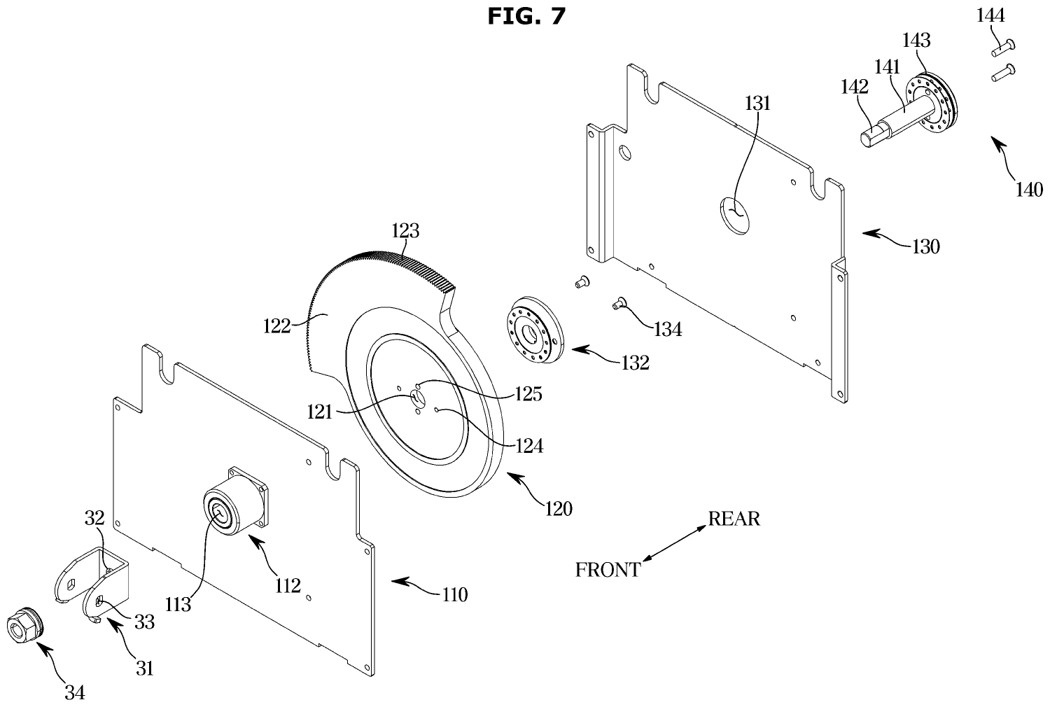

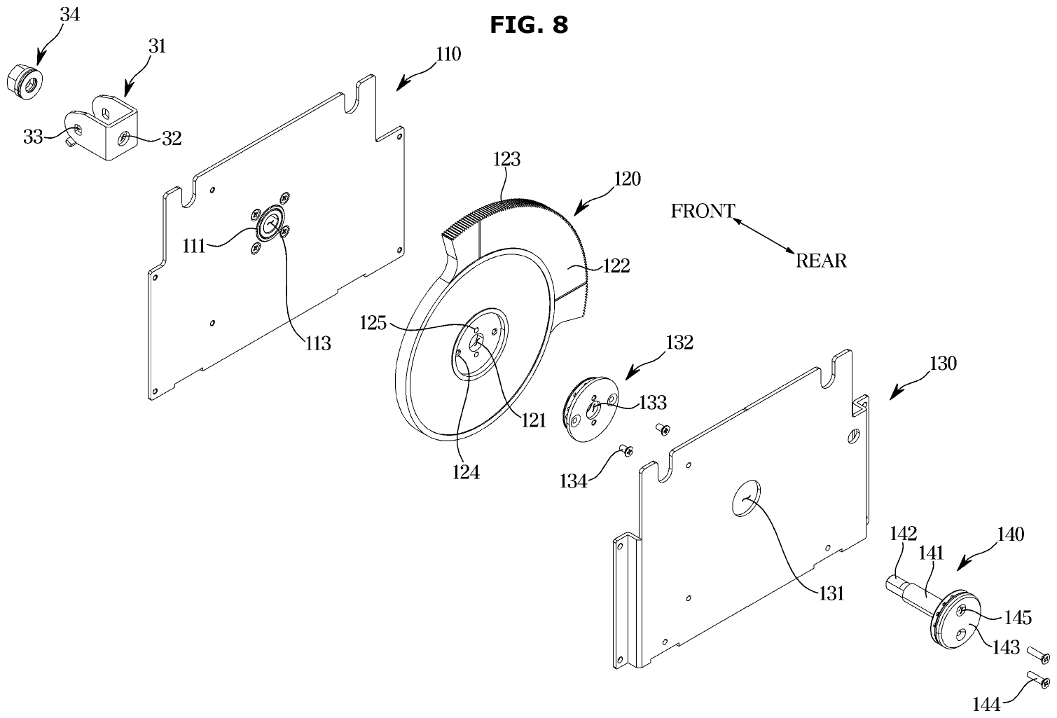

FIG. 7 is an exploded view illustrating main components of a support stand of a display apparatus from an angle according to an embodiment. FIG. 8 is a view illustrating FIG. 7 from another angle.

Referring to FIGS. 7 and 8, the internal structure of the support stand 100 will be described in detail.

The support stand 100 may include a rotating member 120 configured to rotate together with the support arm 30 as the support arm 30 pivots, a first support plate 110 supporting the rotating member 120 at a front side of the rotating member 120, and a second support plate 130 supporting the rotating member 120 at a rear side of the rotating member 120.

The first support plate 110 and the second support plate 130 may support the rotating member 120 moving up and down within the stand 102. The first support plate 110 and the second support plate 130 may be coupled to the stand 102 so as to be slideable in upward and downward directions within the stand 102.

The rotating member 120 may be disposed between the first support plate 110 and the second support plate 130. The rotating member 120 may be configured to rotate with respect to the first support plate 110 and the second support plate 130. The rotating member 120 may be rotatably provided between the first support plate 110 and the second support plate 130.

The rotating member 120 may include a rotating member hole 121 that is a center of rotation of the rotating member 120. The rotating member hole 121 is a hole passing through the rotating member 120 and serving as the center of rotation of the rotating member 120, as described above. A first coupling hole 124 and a second coupling hole 125 may be provided around the rotating member hole 121. The first coupling hole 124 is a hole passing through the rotating member 120, into which a shaft bracket fixing material 134, to be described later, may be inserted. The second coupling hole 125 is a hole passing through the rotating member 120, into which a shaft fixing member 144 may be inserted.

The rotating member 120 may include a first gear portion 123. The first gear portion 123 may be formed along a circumferential direction of the rotating member 120. The rotating member 120 may include a gear connecting portion 122 in which the first gear portion 123 is formed on an outer circumferential surface of the gear connecting portion 122. The gear connecting portion 122 may be a portion of the rotating member 120 having a larger diameter than other portions of the rotating member 120, and may be arranged in an approximately arc shape. The gear connecting portion 122 may be provided along a circumferential direction of the rotating member 120. The first gear portion 123 may be formed on the outer circumferential surface of the gear connecting portion 122. The gear connecting portion 122 may be formed in a range of approximately 90 degrees along the circumferential direction. The first gear portion 123 may be configured to be engaged with a second gear portion 161, which will be described later.

The support stand 100 may include a rotating shaft 140 configured to rotate with the rotating member 120. The rotating shaft 140 may be coupled to the rotating member 120 to rotate together with the rotating member 120.

The rotating shaft 140 may include a first body 141, a second body 142 extending forward from a front end of the first body 141 and having a smaller outer diameter than the first body 141, and a head 143. The head 143 may be provided with a larger outer diameter than the first body 141. The head 143 may be provided with a head hole 145 into which a shaft fixing member 144 is inserted. The shaft fixing member 144 may penetrate the head hole 145 and may be coupled to the second coupling hole 125 of the rotating member 120. The rotating shaft 140 may be coupled to the rotating member 120 to rotate together with the rotating member 120.

A shaft bracket 132 may be provided between the rotating member 120 and the rotating shaft 140. The shaft bracket 132 may be coupled to the rotating member 120 by a shaft bracket fixing member 134. A shaft bracket hole 133 may be formed in the center of the shaft bracket 132. The rotating shaft 140 may be inserted into the shaft bracket hole 133. Specifically, the first body 141 may be inserted into the shaft bracket hole 133.

The rotating shaft 140 may protrude forward of the support stand 100 through a second support plate hole 131 of the second support plate 130, the shaft bracket hole 133, the rotating member hole 121, and the shaft support member hole 113 of the shaft support member 112. The diameter of the shaft support member hole 113 may be smaller than the diameter of the first support plate hole 111 of the first support plate 110. The rotating shaft 140 may be rotatable with respect to the second support plate hole 131 and the shaft support member hole 113.

The second body 142 of the rotating shaft 140 may penetrate a first hole 32 of a first holder 31 and be positioned on an inner side of the first holder 31. At least a portion of the second body 142 that extends through the first hole 32 and is positioned on an inner side of the first holder 31 may be coupled to a fixing member 34. As the fixing member 34 is coupled to the second body 142, the first holder 31 may be coupled to the rotating shaft 140. The first holder 31 may be coupled to the first body 142 to rotate with the rotating shaft 140.

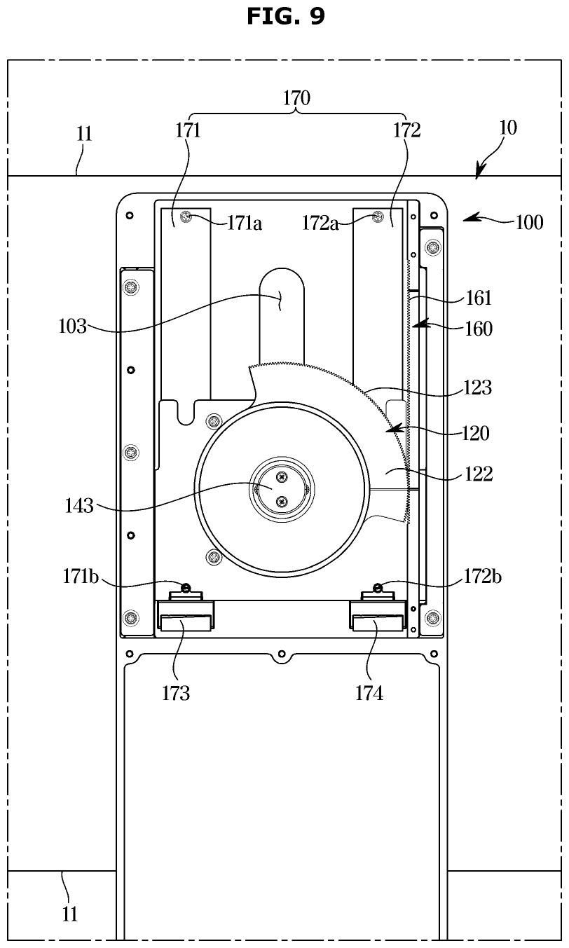

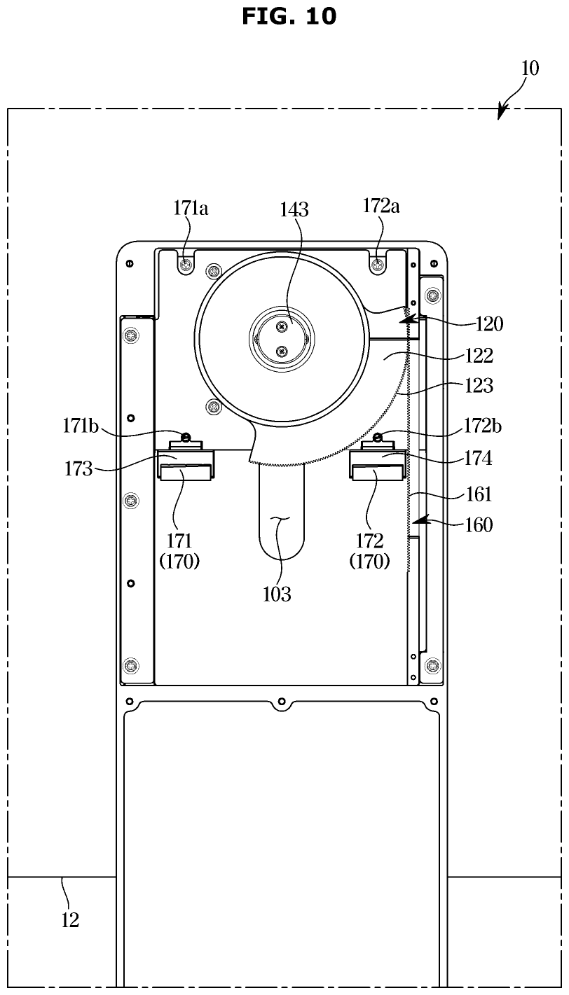

FIG. 9 is a view illustrating an inside of a support stand when a display is laterally disposed in a display apparatus according to an embodiment. FIG. 10 is a view illustrating an inside of a support stand when a display is longitudinally disposed in a display apparatus according to an embodiment.

Referring to FIGS. 9 and 10, the upward and downward movement of the display 10 based on the rotation of the display 10 will be described.

Referring to FIG. 9, when the display 10 is in the first orientation in which the display 10 is disposed horizontally, the display 10 may be positioned at the lowest end within the upward and downward movement range. However, it is not limited to this. When the display 10 is in the first orientation, the display 10 may be located at any position other than the lowest position within the up and down movement range.

When the display 10 is in the first orientation and is positioned at the lowest end of the up and down movement range, one end of the first gear portion 122 of the rotating member 120 and one end of the second gear portion 161 of a guide member 160 may be engaged. The guide member 160 may extend in an upward and downward direction, and may include the second gear portion 161 on one side of the guide member 160. According to an embodiment, the first gear portion 122 may include a pinion gear and the second gear portion 161 may include a rack gear.

Referring to FIG. 9, the support stand 100 may include an elastic member 170. The elastic members 170 may be provided in pairs. The elastic member 170 may include a first elastic member 171 and a second elastic member 172. The elastic members 170 may assist in the upward movement of the rotating member 120 and the first support plate 110. The elastic member 170 may provide elastic force for upward movement of the rotating member 120 and the first support plate 110. To increase the elasticity of the elastic member 170, the elastic member 170 may include the first elastic member 171 and the second elastic member 172, but the number of elastic members is not limited. The elastic member 170 may include three or more elastic members or one elastic member.

One end 171a of the first elastic member 171 may be fixed to a top of the inner surface of the stand 102. The other end 171b of the first elastic member 171 may be fixed to a lower end of the first support plate 110. A first elastic member holder 173 may be provided on the other end 171b side of the first elastic member 171. The first elastic member 171 may be wound and received inside the first elastic member holder 173.

One end 172a of the second elastic member 172 may be fixed to a top of the inner surface of the stand 102. The other end 172b of the second elastic member 172 may be fixed to a lower end of the first support plate 110. A second elastic member holder 174 may be provided on the other end 172b side of the second elastic member 172. The second elastic member 172 may be wound and received within the second elastic member holder 174.

According to an embodiment, the elastic member 170 may include a spiral spring. However, it is not limited to this. The elastic member may include a tension spring and various other types of springs.

Referring to FIG. 10, when the display 10 is positioned in the second orientation of being vertically disposed, the rotating member 120 is rotated approximately 90 degrees, and the rotating member 120 may be positioned at the top end within the up and down movement range.

Referring to FIGS. 9 and 10, when the display 10 is positioned in the first orientation, the rotating member 120 may be positioned at the lowest end of the up and down movement range. At this time, if the display 10 is rotated to be positioned in the second orientation, the separation distance between the display 10 and the floor surface is insufficient, which may cause an edge of the display 10 to collide with the floor surface. As a result, the display 10 may be damaged.

According to an embodiment, the support arm 30 and the rotating member 120 may be configured to rotate together with the display 10 when the display 10 is rotated from the first orientation to be positioned in the second orientation.

When the rotating member 120 located lowermost rotates in a first direction, the first gear portion 122 may move from a bottom of the second gear portion 161 to a top of the second gear portion 161. Accordingly, the rotating member 120 may move upward. After the rotating member 120 is rotated 90 degrees in the first direction, the rotating member 120 may be positioned at its topmost position. As the rotating member 120 rotates 90 degrees in the first direction, the rotating member 120 may move from the lowest position to a highest position. Alternatively, the rotating member 120 may be configured to move from one position to another position above the one position within an up and down movement range as the rotating member 120 is rotated in the first direction.

Conversely, when the rotating member 120 located topmost rotates in a second direction opposite to the first direction, the first gear portion 122 may move from the top of the second gear portion 161 to the bottom of the second gear portion 161. Accordingly, the rotating member 120 may move downwardly. After the rotating member 120 is rotated 90 degrees in the second direction, the rotating member 120 may be positioned at its lowest position. As the rotating member 120 rotates 90 degrees in the second direction, the rotating member 120 may move from the highest position to the lowest position. Alternatively, the rotating member 120 may be configured to move from one position to another position below the one position within an up and down movement range as the rotating member 120 is rotated in the second direction.

As the rotating member 120 moves upward and downward, the first support plate 110 and the second support plate 130 may move upward and downward together. When the rotating member 120 moves upward, the elastic member 170 may provide an elastic force in a direction in which the rotating member 120 moves upward. Accordingly, the display 10 may be moved upwardly by a user simply by rotating the display 10 from the first orientation to the second orientation. The elastic member 170 may prevent the display 10 from moving rapidly downward by providing an elastic force to move the display 10 upward when the display 10 is rotated from the second orientation to the first orientation.

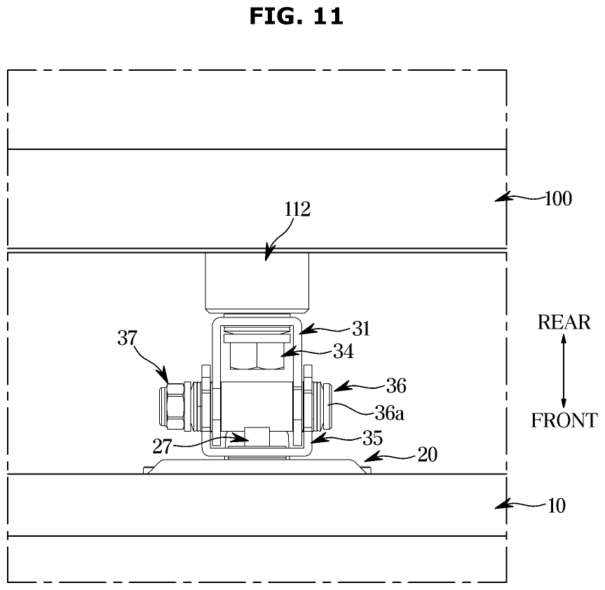

FIG. 11 is an enlarged view illustrating a part of a display apparatus according to an embodiment.

Referring to FIG. 11, a second holder 35 may be coupled to a first holder 31. The second holder 35 may be rotatably coupled to the first holder 31. The first holder 31 and the second holder 35 may be coupled by a tilt shaft 36. The tilt shaft 36 may pass through a second hole 33 (see FIG. 7) of the first holder 31. The tilt shaft 36 may pass through the first holder 31 and the second holder 35. The tilt shaft 36 may be an axis of rotation of the second holder 35 with respect to the first holder 31. A tilt shaft fixing member 37 may be coupled to one end of the tilt shaft 36. The other end 36a of the tilt shaft 36 may have a diameter larger than the second hole 33 and the hole formed in the second holder 35. By such a structure, the tilt shaft 36 may couple the first holder 31 and the second holder 35, and the second holder 35 may rotate with the tilt shaft 36 as the axis of rotation with respect to the first holder 31. When the second holder 35 rotates with respect to the first holder 31, the display 10 coupled with the second holder 35 may tilt rotate.

The second holder 35 and the bracket 20 may be coupled by the bracket retainer 27. The bracket 20 may be rotatable with respect to the second holder 35. When the second holder 35 is fixed, the bracket 20 may be rotatable with respect to the second holder 35. Since the guide protrusion 35a of the second holder 35 is movable from one end of the guide hole 22 of the bracket 20 to the other end of the guide hole 22, the bracket 20 may be rotated with respect to the second holder 35 until the guide protrusion 35a in one end of the guide hole 22 is moved to the other end of the guide hole 22. Conversely, the bracket 20 may be rotated with respect to the second holder 35 until the guide protrusion 35a in the other end of the guide hole 22 is moved to the one end of the guide hole 22.

By providing the second holder 35 to be rotatable with respect to the first holder 31, upward and downward movement of the display 10 is possible even after the display 10 has rotated from the first orientation to the second orientation and positioned on the uppermost end. Similarly, it is possible to move the display 10 up and down even when the display 10 is fixed in the first orientation.

A display apparatus may include a display, a support arm coupled to a rear surface of the display, a support stand coupled to the support arm and configured to move the support arm along a vertical direction, the display is pivotally rotatable between a first orientation in which a long side of the display is laterally disposed and a second orientation in which the long side of the display is longitudinally disposed. The support stand may be configured to upwardly move the display based on the display being rotated from the first orientation to the second orientation, and downwardly move the display based on the display being rotated from the second orientation to the first orientation.

The display and the support arm may be configured to be movable in the vertical direction with respect to the support stand between a first position and a second position higher than the first position.

Based on the display being moved upwardly according to a rotation of the display, and the display is positioned in the second orientation, the display may be configured to be movable along the vertical direction between the first position and the second position.

Based on the display being moved downwardly according to a rotation of the display, and the display is positioned in the first orientation, the display may be configured to be movable along the vertical direction between the first position and the second position.

The support stand may comprise a rotating member configured to rotate together with the support arm, and a guide member configured to guide the rotating member to move upwardly or downwardly.

The rotating member may include a first gear portion formed along a circumferential direction of the rotating member, and the guide member includes a second gear portion extending in the vertical direction and engaged with the first gear portion.

The first gear portion of the rotating member may have a larger diameter than other portions of the rotating member.

The first gear portion may include a pinion gear and the second gear portion may include a rack gear.

The support stand may further include a rotating shaft configured to couple the support arm and the rotating member.

The rotating shaft may be configured to rotate together with the support arm and the rotating member.

The support stand may comprise a support plate configured to move along the vertical direction together with the rotating member with respect to the support stand, and support the rotating member, and an elastic member providing an elastic force to move the rotating member upwardly.

A first end of the elastic member may be fixed to a point on the support stand, and a second end of the elastic member may be fixed to the support plate.

The elastic member may have an elastic force in a direction in which the first end of the elastic member and the second end of the elastic member approach each other.

The elastic member may include a tension spring or a spiral spring.

The display apparatus may further comprise a bracket coupled to a rear surface of the display and coupled to the support arm.

The bracket may be coupled the support arm such that the bracket is pivotally rotatable with respect to the support arm.

The support arm may include a guide protrusion protruding toward the bracket.

The bracket may include a guide hole into which the guide protrusion is inserted, and which limits a range of movement of the guide protrusion.

The guide hole may be in an arc shape.

The guide protrusion may move from one end of the guide hole to the other end of the guide hole as the bracket is rotated with respect to the support arm.

The support arm may be configured to tilt-rotatably support the display.

A display apparatus may include a display, a support arm coupled to a rear surface of the display, and a support stand coupled to the support arm where the support stand is configured to upwardly move the display based on the display being rotated in a first direction from a first orientation to a second orientation different from the first orientation, and downwardly move the display based on the display being rotated in a second direction opposite to the first direction from the second orientation to the first orientation.

According to one aspect of the disclosure, a display apparatus capable of preventing a display from colliding with a floor surface due to being pivotally rotated can be provided.

According to one aspect of the disclosure, a display apparatus capable of preventing a collision between a display and a floor surface by allowing the display to simultaneously perform rotation and upward movement when the display is in a position to collide with the floor surface due to pivot rotation can be provided.

The technical objectives of the disclosure are not limited to the above, and other objectives may become apparent to those of ordinary skill in the art based on the descriptions.

Although the disclosure has been shown and described in relation to specific embodiments, it would be appreciated by those skilled in the art that changes and modifications may be made in these embodiments without departing from the principles and scope of the disclosure, the scope of which is defined in the claims and their equivalents.

What is claimed is:

1. A display apparatus comprising:
a display;
a support arm coupled to a rear surface of the display; and
a support stand coupled to the support arm and configured to move the support arm along a vertical direction,
wherein the display is pivotally rotatable between a first orientation in which a long side of the display is laterally disposed and a second orientation in which the long side of the display is longitudinally disposed, and
wherein the support stand is configured to:
upwardly move the display based on the display being rotated from the first orientation to the second orientation, and
downwardly move the display based on the display being rotated from the second orientation to the first orientation.

2. The display apparatus of claim 1, wherein the display and the support arm are configured to be movable in the vertical direction with respect to the support stand between a first position and a second position higher than the first position.

3. The display apparatus of claim 2, wherein based on the display being moved upwardly according to a rotation of the display, and the display is positioned in the second orientation, and
wherein the display is configured to be movable along the vertical direction between the first position and the second position.

4. The display apparatus of claim 2, wherein based on the display being moved downwardly according to a rotation of the display, and the display is positioned in the first orientation, and
wherein the display is configured to be movable along the vertical direction between the first position and the second position.

5. The display apparatus of claim 1, wherein the support stand comprises:
a rotating member configured to rotate together with the support arm, and
a guide member configured to guide the rotating member to move upwardly or downwardly.

6. The display apparatus of claim 5, wherein the rotating member comprises a first gear portion formed along a circumferential direction of the rotating member, and the guide member comprises a second gear portion extending in the vertical direction and engaged with the first gear portion.

7. The display apparatus of claim 6, wherein the first gear portion comprises a pinion gear and the second gear portion comprises a rack gear.

8. The display apparatus of claim 5, wherein the support stand further comprises a rotating shaft configured to couple the support arm and the rotating member, and
wherein the rotating shaft is configured to rotate together with the support arm and the rotating member.

9. The display apparatus of claim 5, wherein the support stand comprises:
a support plate configured to move along the vertical direction together with the rotating member with respect to the support stand, and support the rotating member, and
an elastic member configured to provide an elastic force to move the rotating member upwardly.

10. The display apparatus of claim 9, wherein a first end of the elastic member is fixed to a point on the support stand, and a second end of the elastic member is fixed to the support plate, and
wherein the elastic member has an elastic force in a direction in which the first end of the elastic member and the second end of the elastic member approach each other.

11. The display apparatus of claim 10, wherein the elastic member comprises a tension spring or a spiral spring.

12. The display apparatus of claim 1, further comprising a bracket coupled to a rear surface of the display and coupled to the support arm, and
wherein the bracket is coupled the support arm such that the bracket is pivotally rotatable with respect to the support arm.

13. The display apparatus of claim 12, wherein the support arm comprises a guide protrusion protruding toward the bracket, and
wherein the bracket comprises a guide hole into which the guide protrusion is inserted and which limits a range of movement of the guide protrusion.

14. The display apparatus of claim 13, wherein the guide hole is in an arc shape, and
wherein the guide protrusion moves from one end of the guide hole to the other end of the guide hole based on the bracket being rotated with respect to the support arm.

15. The display apparatus of claim 1, wherein the support arm is configured to tilt-rotatably support the display.

16. A display apparatus comprising:
a display;
a support arm coupled to a rear surface of the display; and
a support stand coupled to the support arm,
wherein the support stand is configured to:
upwardly move the display based on the display being rotated in a first direction from a first orientation to a second orientation different from the first orientation, and
downwardly move the display based on the display being rotated in a second direction opposite to the first direction from the second orientation to the first orientation.

17. The display apparatus of claim 16, wherein the support stand comprises:
a rotating member configured to rotate together with the support arm, and
a guide member configured to guide the rotating member to move upwardly or downwardly.

18. The display apparatus of claim 17, wherein the rotating member comprises a first gear portion formed along a circumferential direction of the rotating member, and the guide member comprises a second gear portion extending in a vertical direction and engaged with the first gear portion.

19. The display apparatus of claim 18, wherein the first gear portion of the rotating member has a larger diameter than other portions of the rotating member.

20. The display apparatus of claim 18, wherein the first gear portion comprises a pinion gear and the second gear portion comprises a rack gear engaged with the pinion gear.
